(19) United States
(12) Patent Application Publication
(10) Pub. No.: US 2013/0151413 A1
(43) Pub. Date: Jun. 13, 2013

(54) SYSTEMS AND METHODS FOR ENSURING THE APPLICATION OF USER-MANDATED RULES TO PAYMENT TRANSACTIONS

(71) Applicant: RED GIANT, INC, Palo Alto, CA (US)

(72) Inventor: Robert Kern Sears, Palo Alto, CA (US)

(73) Assignee: RED GIANT, INC, Palo Alto, CA (US)

(21) Appl. No.: 13/710,286

(22) Filed: Dec. 10, 2012

Related U.S. Application Data
(60) Provisional application No. 61/568,599, filed on Dec. 8, 2011.

(51) Int. Cl. G06Q 20/40

(52) U.S. Cl. CPC G06Q 20/405
USPC 705/44

(57) ABSTRACT

Systems and methods for controlling and/or authorizing payment transaction are described which may facilitate verification that payment transactions initiated with a payment token of a user are in fact vetted by user-configured rules. According to some examples, a method for controlling payment transactions may include storing a firs and second sets of rules in a database, which rules are configurable by a user. The method may further include communicating and/or applying the first set of rules by a first entity, such as a merchant, a payment network, or other payment acceptance provider. A payment transaction may be routed to a particular network as a result of the application of the first set of rules. During a verification stage, a second set of rules may be applied at the issuer level to determine whether or not user-configured rules have been applied. The transaction may be accepted or decline based on the application of the second set of rules and/or notification may be sent to the user regarding the resolution or the verification stage.

### CROSS-REFERENCE TO RELATED APPLICATIONS

This application claims priority to U.S. Provisional Application No. 61/568,599, filed on Dec. 8, 2011, which provisional application is incorporated herein in its entirety for any purpose by this reference.

### TECHNICAL FIELD

The present application relates generally to payment transaction systems, and describes examples of systems and methods for controlling authorization of payment transactions, for example for ensuring the application of user-mandated rules.

### BACKGROUND

Consumers and businesses now demand more control than ever before over their financial lives. Positive aspirations such as sound financial management and negative issues such as identity theft have moved to front-of-mind for many. Further, increasing numbers of consumers and businesses of all types use digital payment forms rather than cash or check. In this environment, the ability for the user—the consumer or the business—to specify relevant payment system behaviors may be critical.

To facilitate understanding of the examples described herein, a brief discussing of the life cycle of a payment card transaction will be generally described. In general, a payment card (e.g. credit card) transaction may have a life cycle which proceeds according to the following steps, and which life cycle may be applicable to transactions initiated at either a physical point of sale (e.g. retail) or virtual point of sale (e.g. internet or mobile) terminals. The actual processing events or activities may vary depending on the particular merchant, merchant bank, or Issuer, and/or depending on the card and transaction type, and the processing system used.

Initially, a payment card holder (e.g. credit card holder) presents the payment card at the point-of-sale (e.g., merchant). For internet or keyed in transactions, the payment token holder (e.g. cardholder) may provide the virtual point of sale (e.g. online merchant) with the account number, expiration date, billing address and any special codes associated with the payment card. An authorization request is generated by virtue of the previous step and the authorization request is transmitted by the merchant to an acquirer, and from the acquirer to the issuer via a payment network (e.g. Visa or MasterCard Interchange). The Issuer approves or declines the transaction, returning a response via the payment network to the acquirer which then instructs the merchant (e.g. the physical or virtual point-of-sale) as to the transaction. The merchant receives this authorization response and completes the transaction accordingly.

At a certain point in time (for example at the close of a business day), the merchant may close the batch (e.g., all transactions completed that day) and submit the transactions to the acquirer for settlement. The acquirer submits the transactions through the Visa or MasterCard Interchange to the Issuer, which after deducting the interchange fees transmits funds to the acquirer for the authorized transactions (this may also be referred to as clearing or settlement). Once settlement information is received by the Acquirer from the Visa or MasterCard Interchange, the merchant may be credited for the submitted transactions (this step may generally be referred to as funding. Interchange generally facilitates settlement by sending settled transaction information to the issuer and acquirer and providing both with information on what to credit the merchant, what to debit the cardholder and the type and amount of the interchange fees that are to be paid by the acquirer to the issuer. The issuer posts the transactions to the cardholder accounts and sends a statement to its cardholders, requesting payment from the cardholder.

Systems which provide the user (e.g. account holder) with some level of control may have been developed. For example, systems may be known which give the user the ability to set rules for approval, decline and/or alerts and notification of transactions attempted with a payment card of the user. Some such systems apply user-specified rules before, during and/or after a transaction attempt. However, known systems which allow for user control may have shortcomings, as will be further described, and some or all of these shortcoming may be addressed by the examples herein.

### BRIEF DESCRIPTION OF DRAWINGS

Features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1 is an illustration of a payment transaction including systems and methods for controlling the payment transaction according to examples of the present disclosure.

FIG. 2 is an illustration of a payment transaction including systems and methods for controlling the payment transaction according to further examples of the present disclosure.

### DETAILED DISCUSSION

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are implicitly contemplated herein. In some examples, various operations described herein may be divided into additional operations, combined with other operations, or eliminated as may be desired in a particular example.

Certain details are set forth below to provide a sufficient understanding of embodiments of the invention. However, it will be clear to one having skill in the art that embodiments of the invention may be practiced without some of these particular details. Moreover, the particular embodiments of the present invention described herein are provided by way of example and should not be used to limit the scope of the invention to these particular embodiments.

Systems, methods, and software are disclosed for detecting if incoming transactions have been inspected by a rules engine and, based on that determination, applying different sets of rules in an additional phase of the transaction flow. The detection may occur at one or more locations in the greater payment management infrastructure, as shown in the accompanying diagrams.

Example scenarios are described which may address shortcomings in conventional systems relating to payment system behavior. In such conventional systems, if rules concerning approval, decline, alerts, notifications and/or other actions are applied by a rules enforcement entity (which may be referred to as a rules engine) at the network level, some transactions attempted using a payment card (or other payment token which causes a transaction to be cleared using any type of open or closed transaction network) may actually be missed by the rules enforcement entity. For example, in the case of debit cards, transactions may be routed as “credit” transactions, wherein they flow over the “signature transaction” network of the brand on the face of the card (for example, Visa, MasterCard or American Express). Alternatively, the same card may be used to initiate a transaction and the consumer may select “Debit” at the point of sale. In this case, the transaction will be routed over a PIN debit network, not the signature network. If the rules engine is attached only to the signature network in this example, then transactions routed over the PIN debit network will not be seen. In this situation, the user's desired behavior has been thwarted and, very realistically, the user's financial security is threatened or at least undermined by the bypassing of the rules inspection step.

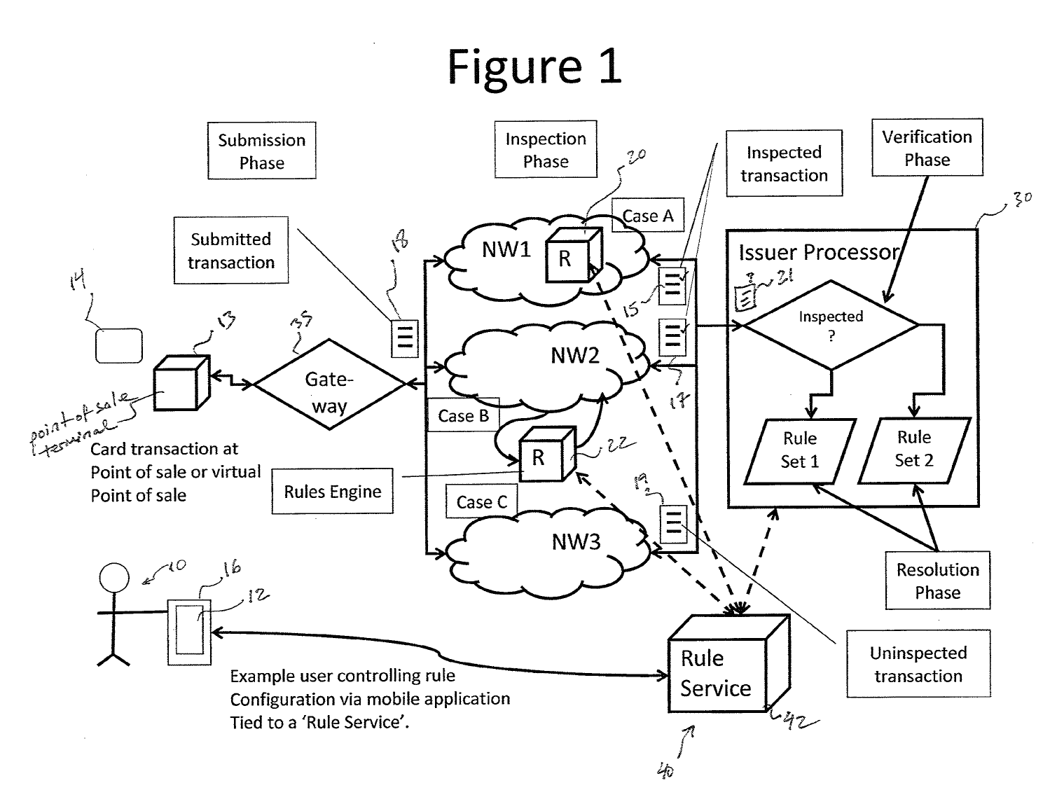

FIG. 1 shows an example configuration including three payment networks (e.g., NW1, NW2, NW3) and a user 10 who controls the rule settings relevant to the payment token 14 to be used to initiate payment transactions. The payment token 14 may be a physical payment card, such as a credit card or a store card, or a virtual payment card, for example a smart card or other payment device associated with an electronic device 16 of the user, for example a smart phone or other portable computing device. FIG. 1 depicts three cases for illustrative purposes. As illustrated in FIG. 1, in Case A, a payment transaction 18 flows over a first payment network (e.g., NW1) with an embedded rules engine 20, which inspects the payment transaction and sends the inspected transaction 15 (or a related message or information relating to the transaction) along to the issuer processor 30. The issuer processor may be a computing device associated or in communication with the issuer of the payment account associated with the payment token 14. As further depicted in FIG. 1, in Case B the payment transaction 18 flows over a second payment network (e.g., NW2) that has a connection to a remote rules engine 22. The second payment network may communicate with the remote rules engine 22 via a wireless or wired network. The rules engine 20, 22 may be configured to store and/or apply one or more user-configured rules from a first set of rules for determining the disposition of an authorization request for the payment transaction 18. The first set of rules may be stored in a database 42 associated with a rules service 40, or they may be stored on a personal computing device of the user 10. In instances in which the user accesses and configures rules stored in database 42, the user may be provided with an interface 12 for setting rules on an electronic device 16 of the user. The rules engine may inspect the payment transaction and/or send the inspected transaction 17 or message or information relating to the transaction back to the second payment network (e.g., NW2) for example, for forwarding the inspected transaction 17 to the issuer processor 30. Further depicted in FIG. 1 is Case C in which the payment transaction 18 flows through a third payment network (e.g., NW3). A rules engine is not associated with the third payment network (e.g., NW3). As such because no rules engine operational under user control is associated with the third payment network, rules for controlling the authorization of the payment transaction 18 may not be applied when transactions flow through NW3, and thus the transaction remains uninspected for conformance with user specifications (e.g., user-configured rules for processing payment transactions). In this example, an uninspected transaction 19 (or message or information relating to the uninspected transaction 19) may be transmitted to the issuer processor 30. Once the transaction (e.g., 15, 17, or 19) or message or information relating to the transaction reaches the issuer processor 30 further rules may be applied to the transaction. A second set of rules configured by the user may be stored in a database 42 associated with a Rules Service 40. The Rules Service 40 may be configured to communicate at least one rule from the second set of rules to a computing device associated with the issuer processor 30. In other examples, the Rules Service may apply the at least one rule from the second set of rules. Applying the second set of rules may depend on a determination of whether or not the transmitted transaction request 21 has been properly inspected. For example, at this stage the transmitted transaction request 21 may be inspected or a message and/or message context associated with the payment transaction may be inspected for indications that the transmitted transaction request 21 corresponds to a payment transaction 18 which has been vetted according to the user-configured rules for processing payment transactions. Based upon this determination, the system may then select a rule set to be applied to the transmitted transaction request 21. For illustrative purposes only, this is shown as a division into rule set 1 and rule set 2. In practice, these could be entirely distinct rule sets, or combinations of rule sets; one could be an actual rule set while the other is a null set; both could be null; both could be applied in sequence, with different ordering depending upon the verification result; or there could be an entirely different scheme. While only two rule sets are shown for illustration, it would be understood that any number of rule sets may be used.

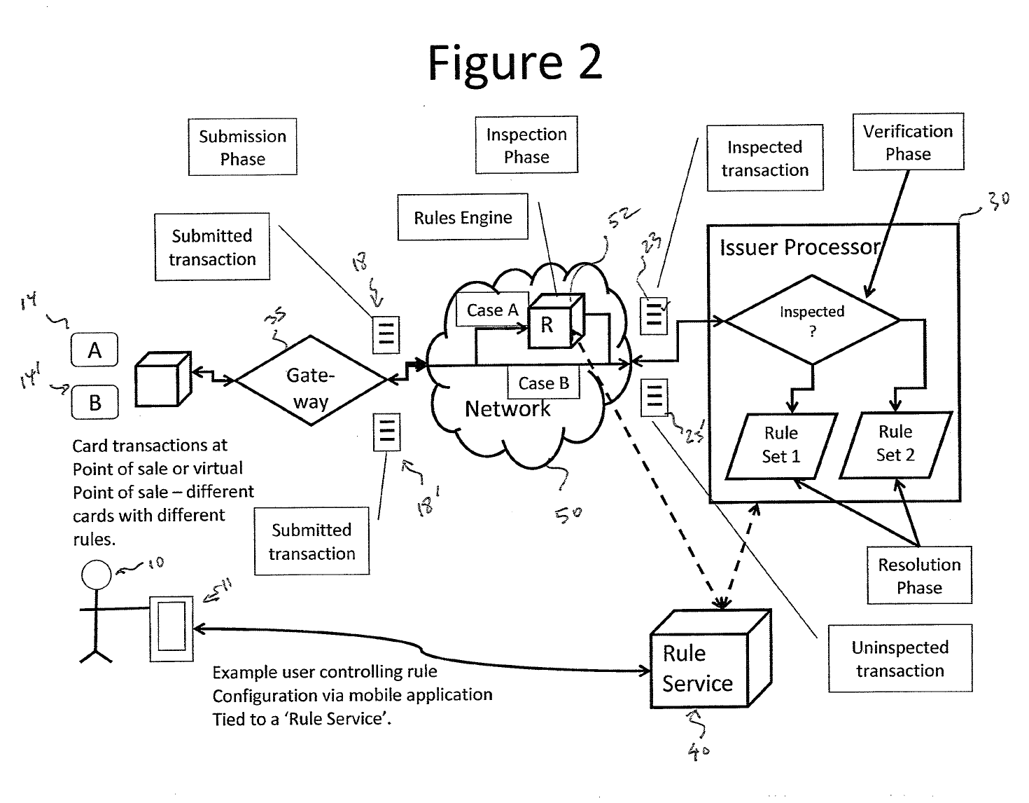

Example operation according to an embodiment of the invention will be described below, and with reference to FIGS. 1 and 2.

For the purposes of illustration, we divide the transaction request into six phases: 1) submission, 2) inspection, 3) verification, 4) resolution, 5) response and 6) reporting. In the submission phase, the transaction is submitted by a merchant acquirer or gateway into a payment network.

As illustrated in FIG. 1, in the inspection phase, the transaction parameters are inspected by (and possibly acted upon by) a rules engine. The rules engine may be resident on a payment network (Case A, NW1), or it may be resident elsewhere and be called by a payment network while the transaction is in progress or thereafter (Case B, NW2). There may also be a payment network that has no such rules enforcement capability provided to the user (Case C, NW3), in which case the payment transaction will not be inspected before the payment transaction request 21 arrives at the issuer processor 30. One additional case occurs when the inspection occurs on the actual payment token (such as a occurring via software within a smart card that inspects programmed payment network rules prior to transmitting payment card information to the gateway 35 and which may vary based on the rules set). Another additional case occurs when inspection occurs via a mechanism integrated with the payment token which occurs after the payment token is accessed to initiate a payment transaction but preceding transmission of the transaction request to the gateway 35 (such as occurring within software on a smart phone wallet application that uses a digital wallet to inspect rules prior to transmitting payment card information, which may vary, prior to submission of the payment transaction request). In both these additional cases, the rules may be altered by the user, which may be an individual or merchant consumer, an entity on behalf of the consumer (e.g. an agent of the consumer), or by third party authorized by the user to modify the rules associated with the payment token of the user.

Once the transaction request has exited the inspection phase (e.g. payment transaction 15, 17, or 19 is transmitted to an issuer processor 30), the transaction enters the verification phase. In the verification phase, the transaction data and/or transaction context are examined to deduce whether or not the transaction has been inspected by a rules engine (e.g. rules engines 20, 22) that would enforce user-configured rules for processing payment transactions. For example, some rules engines may alter the transaction data package (e.g. transmitted transaction request 21) in a detectable way to indicate that they have, indeed, inspected the transaction request. In other cases, it may be necessary to deduce from context if the transaction has been inspected. For example, if a transaction is presented for verification via a payment network that has no rules engine associated therewith that is enforcing the user's desired behavior (e.g., rules for processing payment transactions), then the verification system can clearly determine that the transaction has not been inspected for conformity with the user's specifications (e.g., rules for processing payment transactions). This situation is shown as Case C in FIG. 1.

The outcome of the verification phase may be the application of a second set of rules configurable by the user, which may be different for transaction requests that have been inspected (e.g., as in Case A and B) vis-a-vis those that have not been inspected (e.g., as in Case C). Consider the case of a consumer user who wants to enforce time of day restrictions on purchases made with his or her charge card. By configuring a set of rules residing in or executed by a network-based rules engine (e.g., as may be associated with NW1 or NW2) the consumer may institute time of day limitations which would be applied to the charge card when the charge card is used to initiate a transaction. The user may configure a set of rules through interaction with the rules service 40, which rule service 40 may be operatively coupled to electronically provide the relevant rules from the user-configured rule sets to the network-based rules engine as needed. If such a user required application of rules is not accompanied by a verification system such as the one described herein, however, the consumer's time of day restrictions may be circumvented in the case where the transaction requests are routed over an alternative network (e.g., NW3) that does not have a rules engine configured according to the consumer's specifications.

Embodiments of the invention eliminate this possibility by inspecting the incoming transaction requests and applying appropriate behavior in an operation we describe as the resolution phase. Continuing with our time of day example, consider the case where a transaction is presented for verification. If the verification step deduces that the transaction was inspected by a rules engine as directed by the consumer, then rules set 1 may be applied during the resolution phase. The behavior specified by this rule set 1 is not limiting in the scope of the present disclosure. Any behavior may be specified as part of the rule set 1, rule set 2 or other rule sets. For purposes of illustration only, suppose that the user has directed that all transactions approved by the rules engine should generate an SMS alert to the consumer's mobile phone. When a transaction that is verified by the issuer processor 30 as having been vetted by a rules engine operating in accordance with the user-configured set of rules, then the rule set 1 may cause an SMS to be sent to the consumer, for example to a portable electronic device of the consumer 11. Further, suppose the consumer has directed that any transactions that cannot be verified as having been examined by a rules engine should be declined. In that case, if a transaction arrives that cannot be shown to have been inspected, then the resolution phase will call rule set 2. Rule set 2 will, in this example, decline the transaction. As with the discussion around rule set 1, there is no limitation to behavior implied in the resolution phase. An optional message may be sent to the user 10 upon declining of the transaction as may be dictated by rule set 2.

The verification and resolution phases may actually occur at the issuer processor 30, at a third-party service provider (e.g. a computing device associated with the rules system 40, for example), or elsewhere. The salient consideration is that transactions that have been inspected according to the user's requirements may be treated differently from transactions that have not been so inspected.

Upon completion of the resolution phase of the transaction, typically two additional phases will begin. One, the response phase, has the issuer processor 30 or a related party send a response back to the payment network for forwarding to the point of sale (or virtual point of sale) 13 via gateway 35. The response may include an authorization or a decline of the payment transaction initiated by payment token 14, for example. An optional reporting phase may occur at the time of or after the response phase. In the reporting phase, the user 10 may be alerted as to the attempted transaction and/or the results of the attempted transaction, for example. The reporting phase may also be used to log results, to classify transactions, provide transaction information to other authorized entities for financial or other use (e.g. a financial research firm, a financial security firm, a loyalty program, or a marketing company), and so forth.

Rules applied to each transaction may differ on a per-card (or per-token, or per-transaction) basis. Thus, different users may have entirely different requirements for rules. In addition, some users may require application of rules to transactions associated with a particular card while not requiring application of rules to transactions associated with a different card. Further, other users may not require application of rules at all. For example, illustrated in FIG. 2 is a configuration wherein transactions initiated by two different payment tokens 14, 14′ (e.g. credit cards or virtual tokens A and B) flow across the same network 50. Transactions 18 initiated with payment token 14 (e.g. card A) are inspected by the rules engine 52 (illustrated as Case A), while transactions 18′ initiated with payment token 14′ (e.g., card B) are not inspected by a rules engine (illustrated as Case B). The inspecting during the inspection phase may include the application of one or more rules configured by the user for governing payment transactions, which rules may be accessible to only to the user or entities authorized by the user. As a result, an inspected transaction (e.g. transaction request 23) is transmitted to the issuer processors 30 in response to the transaction 18 initiated with payment token 14. An uninspected transaction (e.g. transaction request 23′) is transmitted to the issuer processors 30 in response to the transaction 18′ initiated with payment token 14′. The issuer processor 30 or a computing device in communication with the issuer processor 30 (e.g., a computing device associated with the rule service 40) further inspects the transaction requests 23. 23′ in the verification phase and selects rule set 1 or rule set 2, accordingly. As noted in the discussion of FIG. 1, above, the designation of rule set 1/rule set 2 is for purposes of illustration only.

While the foregoing detailed description has set forth various examples of the devices and/or processes via the use of block diagrams, flowcharts, and/or examples, such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. As examples, physical or virtual point of sale terminals (e.g. point-of sale 13), rules engines (e.g., 20, 22, and/or 52), payment gateways 35, issuer processors 30, and other components of the systems depicted in FIGS. 1 and 2 and described herein, may be implemented and/or include one or more computer hardware or software components. In one example, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the examples disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein are capable of being distributed as a program product in a variety of forms, and that an illustrative example of the subject matter described herein applies regardless of the particular type of signal bearing medium used to actually carry out the distribution. Examples of a computer readable medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.). Those skilled in the art will recognize that it is common within the art to describe devices and/or processes in the fashion set forth herein, and thereafter use conventional engineering practices to integrate such described systems and/or methods into data processing systems. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems

Embodiments of the invention may provide systems and methods which enable a user to safeguard against situations in which rules required by the user to be applied to payment transaction are circumvented. For example, the user may require rules to be applied to transactions initiated with a payment token associated with payment account of the user, and the rules engine may be appropriately configured to applied the rules set or configured by the user, yet due to a circumstance beyond the user's control, transactions initiated with the payment token of the user may flow across the network uninspected. This may be a consequence of, for example, a system outage, a misconfiguration, or a delay between configuration of the rules engine and routing of transactions through the engine.

Some advantages of examples of the present invention are described herein to facilitate understanding of the disclosure. It is to be understood that not all embodiments of the present invention may enjoy all, or even any, of the described advantages.

What is claimed is:

1. A method of authorizing a payment transaction, the method comprising:
storing in a database a first set of rules and a second set of rules for governing payment transactions initiated with a payment account of a user, wherein said first set of rules and second set of rules are configured by the user;
in response to a payment transaction having been initiated with a payment token associated with the payment account of the user, electronically communicating at least one rule from the first set of rules to a first computing device associated with or in communication with a first entity different from the user, such that the at least one rule from the first set of rules is applied to the payment transaction prior to or at the time of submission of a transaction authorization into a payment network;
electronically communicating to a second computing device associated with or in communication with a second entity at least one rule from the second set of rules in response to the transaction authorization having been transmitted to the second entity, wherein the second entity is different from the user and the first entity, such that the at least one rule from the second set of rules is applied to the transaction authorization to determine whether the payment transaction has been inspected by an approved rules engine; and
authorizing or declining the payment transaction based on the application of the at least one rule from the second set of rules.

2. The method of claim 1, wherein the user is an individual consumer, a merchant consumer, or an agent of the individual or merchant consumer, wherein the first entity is a merchant retailer, an acquirer of the merchant retailer, a payment gateway, or other payment acceptance provider, and wherein the second entity is a card network associated with or an issuer of the payment account of the user.

3. The method of claim 1, wherein the user is an individual consumer, and wherein the first set of rules and the second set of rules are accessible to the individual consumer and are inaccessible to entities other than the individual consumer.

4. The method of claim 1, wherein the first entity is a merchant, and wherein application of the at least one rule of the first set of rules and the at least one rule of the second set of rules is performed by the merchant.

5. The method of claim 1, wherein the payment token associated with the payment account of the user resides on a secured smart phone or a smartcard.

6. The method of claim 1, further comprising after submitting the payment transaction to a first payment network, forwarding the payment transaction to a second payment network for processing by the second network based on the at least one rule from the first set of rules of the resolution process.

7. The method of claim 1, wherein the second entity is a card issuer, and wherein application of the at least one rule of the first set of rules and the at least one rule of the second set of rules is performed by a computing device associated with the card issuer.

8. The method of claim 1, wherein the second entity is an issuer of a primary financial account associated with the user which primary financial account is not a payment card, and wherein application of the at least one rule of the first set of rules and the at least one rule of the second set of rules is performed by a computing device associated with the issuer of the primary financial account.

9. The method of claim 1, further comprising reporting to a third party information relating to the response to the transaction authorization, wherein said third party is the same as the user, the first entity or a financial institution associated with the user or first entity.

10. The method of claim 1, further comprising adding by the first computing device additional parameters to the parameters of the payment transaction as transmitted to the first computing device.

11. The method of claim 1, wherein application of the at least one rule from the second set of rules includes detecting whether one or more parameters of the transaction have been altered by the first entity.

12. The method of claim 1, wherein application of the at least one rule from the second set of rules includes detecting whether the payment transaction originated from a payment network which is known to perform inspection with an approved rules engine.

13. A computer readable medium with instructions stored thereon to be executed by one or more processors of a payment network, a card issuer, or one or more computing devices in communication with the payment network or card issuer for applying and verifying an application of user configured rules to a payment transaction, which instructions when executed cause the one or more processors to:
provide an electronic interface to a user to configure one or more rules governing a response to a request for authorization of a payment transaction initiated with a payment token of the user;
store a first set of rules configured by the user for inspecting a payment transaction by a first entity and a second set of rules configured by the user for verifying the inspection of the payment transaction by a second entity;
provide at least one rule from the first set of rules to the first entity different from the user in response to the payment transaction being initiated; and
provide at least one rule from the second set of rules to the second entity different from the first entity or the user in response to a payment transaction being transmitted to the second entity for authorization; and
authorize or decline the payment transaction based on the first set of rules and the second set of rules.

14. The computer readable medium of claim 13, wherein the first set of rules and the second set of rules are accessible to the user and are not accessible to the first entity or the second entity.

15. The computer readable medium of claim 13 including further instructions for causing the one or more processor to report information relating to the response to the request for authorization of the payment transaction.

16. The computer readable medium of claim 13, wherein the user is a consumer or a merchant which is an account holder of an account associated with the payment token, or an agent of the consumer or merchant.

17. The computer readable medium of claim 13, wherein the payment token is one or more of a credit card, a store payment card, a virtual payment card, or other payment account of the user.

18. The computer readable medium of claim 13, wherein the least one rule from the first set of rules specifies a particular payment network which is allowed to process transactions initiated with the payment token.

19. The computer readable medium of claim 13, further configured to provide the at least one rule from the first set of rules to the first entity prior to the request for authorization of the payment transaction is submitted to the payment network for determining which payment network is allowed to process transactions initiated with the payment token.
